(19) United States
(12) Patent Application Publication
(10) Pub. No.: US 2008/0309505 A1
(43) Pub. Date: Dec. 18, 2008

(54) Current-differential relay device

(75) Inventors: Takashi Sorimachi, Tokyo (JP); Takashi Hattori, Tokyo (JP)

Correspondence Address: BUCHANAN, INGERSOLL & ROONEY PC, POST OFFICE BOX 1404, ALEXANDRIA, VA, 22313-1404, US

(73) Assignee: Mitsubishi Electric Corporation, Tokyo (JP)

(21) Appl. No.: 12/213,358

(22) Filed: Jun. 18, 2008

(30) Foreign Application Priority Data
Jun. 18, 2007 (JP) 2007-160764
Dec. 27, 2007 (JP) 2007-337980

(51) Int. Cl. G08B 21/00

(52) U.S. Cl. 340/664

(57) ABSTRACT

A relay device, installed at one end of a power line within a protected zone, includes a processor performing a transmitting process that transmits first sampling current data of the power line at the one end to another relay device installed at the other end, through a 2048-kbps transmission line, and a receiving process that receives second sampling current data of the power line at the other end from the another relay device through the transmission line; a calculator calculating a difference, used for detection of an occurrence of fault, between the first and the second sampling current data; and a human-machine interface capable of receiving and presenting information through a display unit. The processor transmits the first sampling current data in a transmission frame, and transmits, using an unused field not for the sampling current data in the transmission frame, display-related data output from the human-machine interface.

### BACKGROUND OF THE INVENTION

1. Field of the Invention

The present invention relates to a current-differential relay device capable of detecting a fault in a protected zone.

2. Description of the Related Art

One approach to detecting a fault of a power transmission line within a protected zone is to install a pair of current-differential relay devices respectively in both ends of the power transmission line. In such a system, one current-differential relay device transmits sampling current data obtained by sampling current flowing at one end of the power transmission line to the other current-differential relay device via a predetermined signal transmission line, and receives sampling current data at the other end of the power transmission line from the other current-differential relay device. The one current-differential relay device then calculates a difference in electric current between the sampling current data of current detected by the one current-differential relay device and the sampling current data transmitted from the other current-differential relay device to detect the fault in the protected zone.

As to the data transmission between the current-differential relay devices, each current-differential relay devices performs sampling of phase current data in a cycle of 30 degrees, and one current-differential relay device transmits and receives the sampling current data to and from the other current-differential relay device via a 54-kbps (or 64-kbps) signal transmission line. Then, a difference in electric current between the sampling current data by the one current-differential relay device and the sampling current data by the other current-differential relay device is calculated and it is determined that a fault occurs if the difference is more than a predetermined value. In addition, an unused bit of transmission information is assigned for on/off information (positive or negative data) of the current-differential relay device, thereby enabling the receiving end to determine the failure of transmission or to use it for estimation of device operation information for a protection device for example (see Japanese Patent Application Laid-open No. 2005-176440). This technique is suitable for determining a failure of transmission and for identifying the operation state of the device, as described in JP-A No. 2005-176440.

Although the conventional technique for transmission, as described in JP-A No. 2005-176440 can be applied to determining a failure of transmission and identifying the operation state of the device, it is not suitable for analyzing failure based on information that one current-differential relay device in operation receives from the other current-differential relay device, and for obtaining data for relay device maintenance. Moreover, the analysis based on data obtained by one current-differential relay device in operation from the other current-differential relay device, requires either an operator to go off to the place the other current-differential relay device is installed and to directly obtain the data from the other current-differential relay device, or a remote monitoring control system to be installed in each substation with a connection interface to the current-differential relay devices.

Accordingly, in order to obtain the setting value, states of relay elements, and device input/output signals of the other current-differential relay device for the purpose of analysis in relay operation, every when a fault occurs, the conventional current-differential relay device requires either the operator to go off to the place where the other current-differential relay device is several tens of kilometers far away from the one current-differential relay device, or a specific monitoring control system to be installed in advance. This leads to problems that take long time to properly operate with data analysis and need equipment investment.

### SUMMARY OF THE INVENTION

It is an object of the present invention to at least partially solve the problems in the conventional technology.

According to an aspect of the present invention, a current-differential relay device, installed at one end of a power transmission line within a protected zone, includes a transmission data processor for performing a transmitting process that transmits first sampling current data obtained by sampling current flowing the power transmission line at the one end to another current-differential relay device installed at the other end of the power transmission line within the protected zone, through a predetermined signal transmission line, and a receiving process that receives second sampling current data obtained by sampling current flowing the power transmission line at the other end from the another current-differential relay device through the signal transmission line; a differential calculator for calculating a difference in electric current between the first sampling current data and the second sampling current data, the difference being used for detection of an occurrence of fault in the protected zone; and a human-machine interface capable of receiving and presenting information through a display unit. The signal transmission line has a transmission rate of 2048 kbps or higher. The transmission data processor transmits the first sampling current data in a transmission frame used in the signal transmission line, and transmits, using an unused field not for the sampling current data in the transmission frame, display-related data that is output from the human-machine interface.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 shows a system configuration of a first embodiment of a current-differential relay device according to the present invention;

FIG. 2 shows a transmission frame of sampling current data that is transmitted from a first current-differential relay device to a second current-differential relay device;

FIG. 3 shows a transmission frame of sampling current data that is transmitted from the second current-differential relay device to the first current-differential relay device;

FIG. 4 shows a transmission frame of HMI instruction data (a request for transmitting a setting value) that is transmitted from the first current-differential relay device to the second current-differential relay device in the first embodiment;

FIGS. 5A and 5B show transmission frames of HMI response data (a setting value) that are transmitted from the second current-differential relay device to the first current-differential relay device in the first embodiment;

FIG. 6 shows a transmission frame of HMI instruction data (a request for transmitting an event log) that is transmitted from the first current-differential relay device to the second current-differential relay device in a second embodiment;

FIGS. 7A to 7C show transmission frames of HMI response data (an event log) that are transmitted from the second current-differential relay device to the first current-differential relay device in the second embodiment;

FIGS. 8A and 8B show transmission frames of HMI instruction data (a request for setting a setting data) that are transmitted from the first current-differential relay device to the second current-differential relay device in a sixth embodiment;

FIG. 9 shows a transmission frame of HMI response data (a result of setting the setting data) that is transmitted from the second current-differential relay device to the first current-differential relay device in the second embodiment;

FIG. 10 shows a system configuration of a seventh embodiment of a current-differential relay device according to the present invention;

FIGS. 11A and 11B show transmission frames of HMI instruction data (time information) that are transmitted from the first current-differential relay device to the second current-differential relay device in the seventh embodiment; and

FIG. 12 shows a transmission frame format that conforms to ITU-T G.704 standard.

### DETAILED DESCRIPTION OF THE PREFERRED EMBODIMENTS

Exemplary embodiments of a current-differential relay device according to the present invention will be explained below in detail with reference to the accompanying drawings. Note that the invention is not limited to the embodiments.

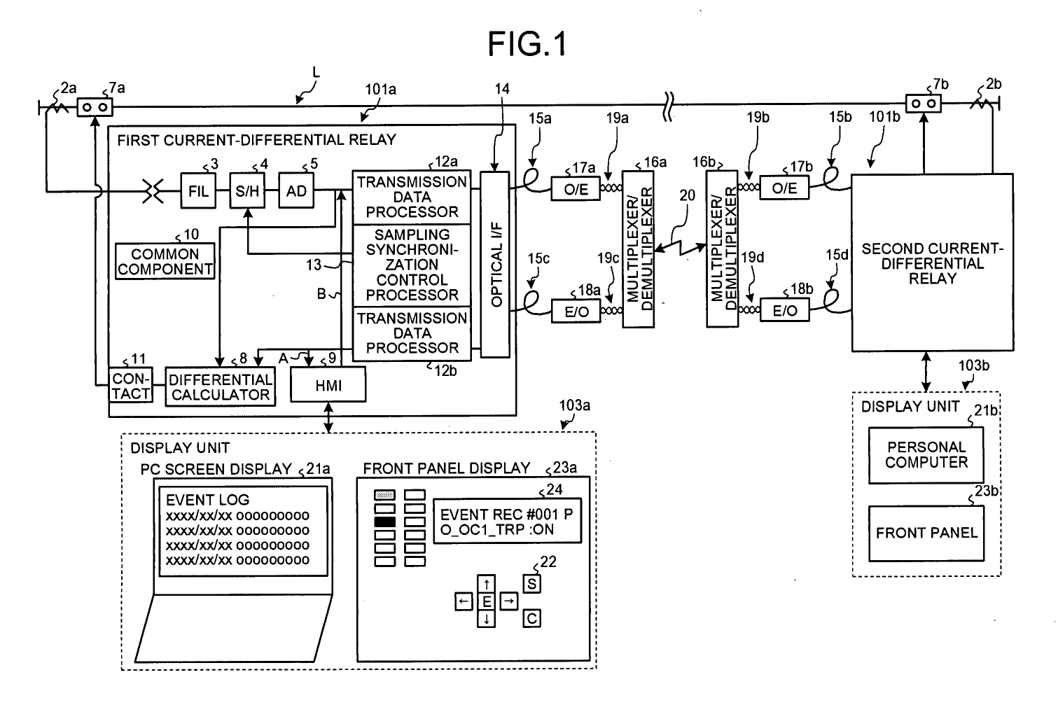

FIG. 1 shows a system configuration of a first embodiment of a current-differential relay device according to the present invention. In FIG. 1, two current-differential relay devices are installed respectively in both ends of a power transmission line L within a protected zone so as to connect to the ends. A first current-differential relay device 101a, of the current-differential relay devices, is connected to one end of the power transmission line L within the protected zone. An output terminal of the first current-differential relay device 101a is connected to a breaker 7a that is provided in the power transmission line L, through a contact 11. A second current-differential relay device 101b, which is connected to the other end of the power transmission line L within the protected zone, has the same configuration as the first current-differential relay device 101a. The first current-differential relay device 101a is connected to the power transmission line L through a current transformer (CT) 2a which is provided in the power transmission line L. Likewise, the second current-differential relay device 101b is connected to the power transmission line L through a current transformer 2b and a breaker 7b which are provided in the power transmission line L, and an output terminal of the second current-differential relay device 101b is connected to a breaker 7b that is provided in the power transmission line L, through a contact (not shown).

The first current-differential relay device 101a includes a filter 3, a sample-hold circuit 4, an A/D converter 5, a differential calculator 8, a human-machine interface (HMI) 9, a common component 10, the contact 11, transmission data processors 12a and 12b, a sampling synchronization control processor 13, and optical interface (I/F) 14.

Operation of the current-differential relay devices will be described below. Sampling current data that is input to the first current-differential relay device 101a through the power transmission line L and the current transformer 2a is converted into data to be contained in a predetermined transmission frame through the filter 3, the sample-hold circuit 4, the A/D converter 5, and the transmission data processor 12a, and then transmitted to the second current-differential relay device 101b through the optical interface 14, an optical fiber 15a, an O/E unit (optical-to-electrical converter) 17a, a cable 19a, a multiplexer/demultiplexer 16a, and a signal transmission line (optical fiber) 20.

On the other hand, sampling current data that is detected by the second current-differential relay device 101b and received by the multiplexer/demultiplexer 16a through the optical fiber 20 is input to the transmission data processor 12b through a cable 19c, an E/O unit (electrical-to-optical converter) 18a, an optical fiber 15c, and the optical interface 14. The differential calculator 8 calculates a difference in electric current between the pieces of sampling current data input, that is, the sampling current data detected by the first current-differential relay device 101a and the second current-differential relay device 101b, respectively. The differential calculator 8 also transmits a signal indicating the occurrence of fault to the breaker 7a through the contact 11 if the difference is more than a predetermined value. In response to this signal, the breaker 7a cuts the current flowing the power transmission line L.

The HMI 9 receives transmission data from the second current-differential relay device 101b through the transmission data processor 12b, as shown with arrow A in FIG. 1, and extracts data related to display from the transmission data. The HMI 9 then displays the extracted data on an LCD 24 of a front panel 23a or a screen of a personal computer (PC) 21a in a display unit 103a. In other words, the HMI 9 establishes a human-machine interface means for giving a display on a display means such as the front panel 23a or the personal computer 21a. The HMI 9 also adds, in the transmission information which is already converted into a predetermined transmission frame format, instruction information which is generated according to input operation of a push button 22 of the front panel 23a or the personal computer 21a, and transmits it to the second current-differential relay device 101b, as shown with arrow B in FIG. 1. The second current-differential relay device 101b includes a display unit 103b which is the same as the display unit 103a of the first current-differential relay device 101a.

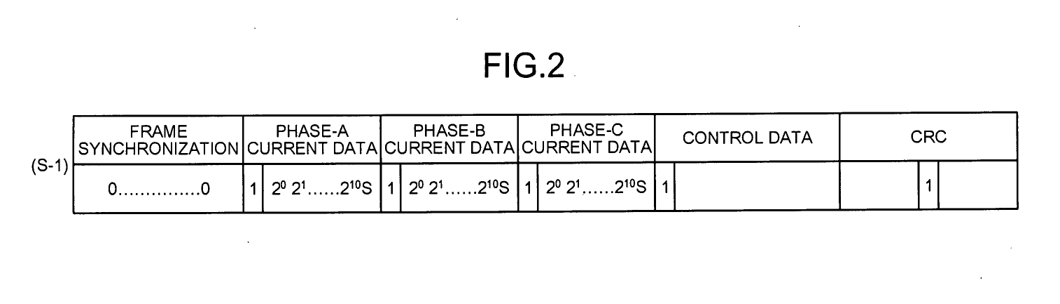

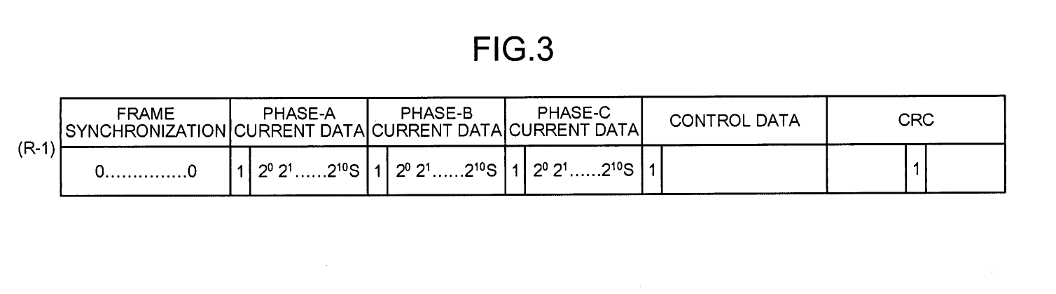

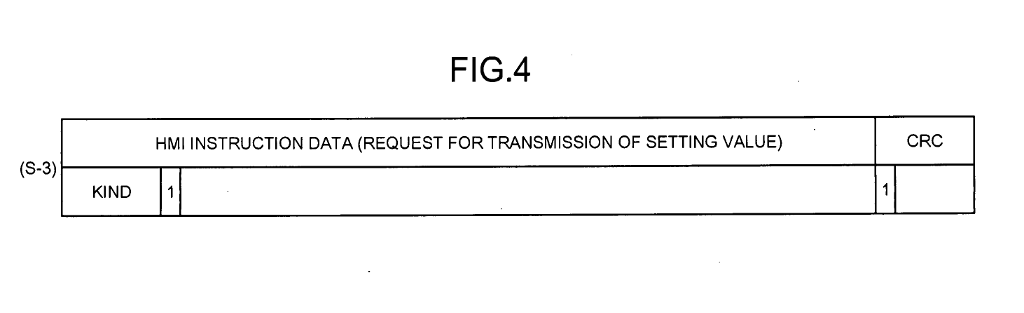

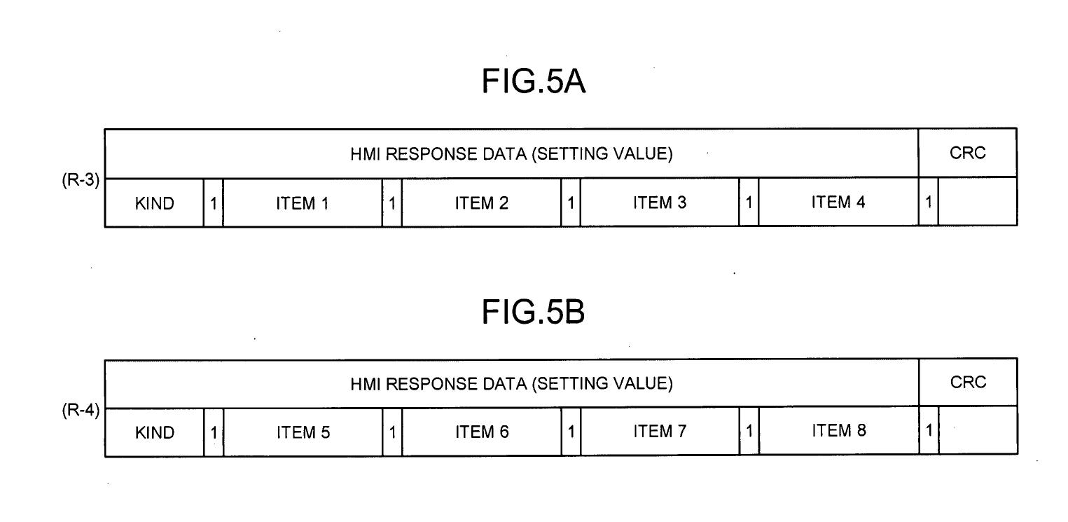

FIGS. 2 to 5 show examples of the transmission data of the first embodiment. FIGS. 2 and 4 show examples of transmission data to be transmitted from the first current-differential relay device 101a to the second current-differential relay device 101b. FIGS. 3 and 5 show examples of transmission data to be transmitted from the second current-differential relay device 101b to the first current-differential relay device 101a.

In FIG. 2, transmission data S-1 to be transmitted from the first current-differential relay device 101a to the second current-differential relay device 101b is data stream that includes a frame synchronization, a piece of the sampling current data containing phase-A current data, phase-B current data, and phase-C current data, predetermined control data, and CRC (Cyclic Redundancy Code). This data stream is assigned to a predetermined channel, and transmitted in the frame format conforming to ITU-T G.704 to the second current-differential relay device 101b.

In FIG. 3, transmission data R-1 to be transmitted from the second current-differential relay device 101b to the first current-differential relay device 101a is data stream that includes a frame synchronization, a piece of the sampling current data containing phase-A current data, phase-B current data, and phase-C current data, predetermined control data, and CRC. This data stream is assigned to a predetermined channel, and transmitted in the frame format conforming to ITU-T G.704 to the first current-differential relay device 101a. In other words, the transmission data R-1 has the same structure as the transmission data S-1.

The transmission data S-1 and R-1 are sampling current data obtained by sampling the current in an electric phase angled of 30 degrees, which is the same as the conventional one, and always transmitted from the first current-differential relay device 101a and the second current-differential relay device 101b. Note that these sampling current data are transmitted over a 2048-kbps signal transmission line in place of a 54-kbps or 64-kbps signal transmission line, in the first embodiment.

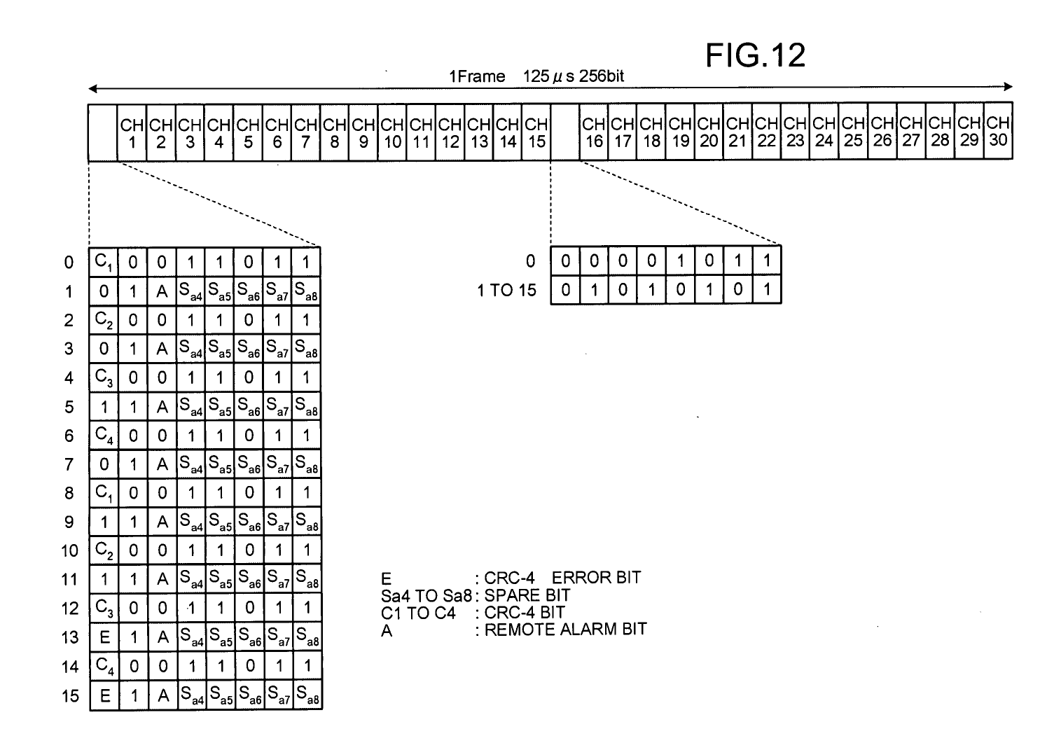

The transmission frame format conforming to ITU-T G.704 will be briefly described below. FIG. 12 shows the transmission frame format conforming to ITU-T G.704 standard. As shown in FIG. 12, according to this transmission frame format, 256 bits per frame length are transmitted in 125 μs. Therefore, the transmission rate of the transmission frame is 2048 kbps (=256/(125×10⁻⁶)). The transmission frame format also defines a frame divided into 32 channels, and therefore each of the 32 channels carries 8 bits (=256/32). CH1 to CH30, of the 32 channels, are available for data. The sampling current data is transmitted in a predetermined channel of the data available fields (CH1 to CH30).

In FIG. 4, transmission data S-3 to be transmitted from the first current-differential relay device 101a to the second current-differential relay device 101b is a piece of the sampling current data (transmission data items), specifically, HMI instruction data (a request for transmitting a setting value) for requesting a setting value of the second current-differential relay device 101b. In response to a predetermined input operation with the push button 22 on the front panel 23a, the HMI 9 adds the HMI instruction data (a request for transmitting a setting value) in the transmission information of the first current-differential relay device 101a and transmits it.

In FIGS. 5A and 5B, transmission data R-3 and transmission data R-4 to be transmitted from the second current-differential relay device 101b to the first current-differential relay device 101a each indicate a setting value that the HMI 9 of the second current-differential relay device 101b returns in response to the HMI instruction data (a request for transmitting a setting value), specifically, HMI response data (a setting value) as a piece of the sampling current data.

The transmission data S-3, R-3, and R-4 being the display-related data are transmitted using fields containing no sampling current data (unused fields in the transmission frame format). Since this type of setting value has a lot of information, it is transmitted with a plurality of blocks as one example in the first embodiment.

As described above, the current-differential relay devices use transmission data processor for the 2048-kbps transmission instead of that for the conventional 64-kbps transmission and always transmit the sampling current data in the transmission frame format conforming to ITU-T G.704 standard as shown in FIG. 12 over the 2048-kbps transmission line. The current-differential relay devices also use unused fields in the transmission frame format and transmit and receive display-related data such as HMI instruction data (a request for transmitting a setting value) and HMI response data (a setting data) to and from one another. Therefore, sampling current data and display-related data can be simultaneously transmitted and received.

In this way, since the current-differential relay devices according to the first embodiment transmit the display-related data (transmission data items) other than the sampling current data in the transmission frame for transmitting the sampling current data, one current-differential relay device can quickly obtain the display-related data of the other current-differential relay device and improve analysis function, without additional specific monitoring control system and without on-site operation of the other current-differential relay device.

The first current-differential relay device 101a and the second current-differential relay device 101b are connected to each other by a signal transmission line including the optical fibers 15a to 15d, the O/E units (optical-to-electrical converters) 17a and 17b, the E/O units (electrical-to-optical converters) 18a and 18b, the cables 19a to 19d, multiplexers/demultiplexers 16a and 16b, and the optical fiber 20. However, the signal transmission line connecting the first current-differential relay device 101a and the second current-differential relay device 101b is not limited to the above components, and may be provided as a direct connection between the optical interface 14 and the optical fiber 20, for example.

The transmission data S-3, R-3, and R-4 in the first embodiment are contained in unused fields, which are other than fields containing the sampling current data, in the transmission frame format as shown in FIG. 12, and transmitted in synchronization with the sampling current data. However, these transmission data S-3, R-3, and R-4 as being the display-related data may be transmitted separately in the transmission frame format as shown in FIG. 12, not in synchronization with the sampling current data.

In the first embodiment, the sampling current data and the display-related data are transmitted over the 2048-kbps signal transmission line, but it goes without saying that the data can be transmitted over a signal transmission line of more than 2048 kbps.

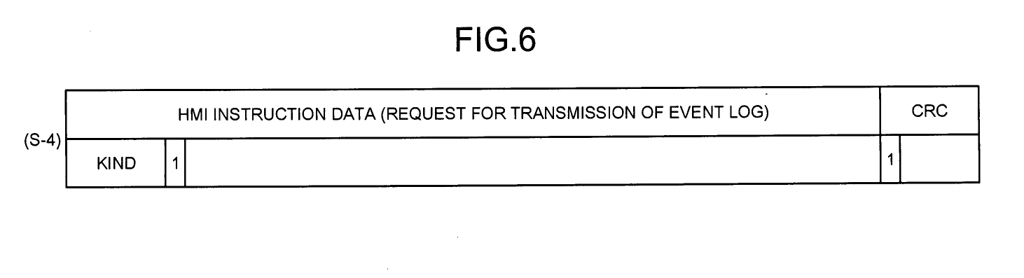

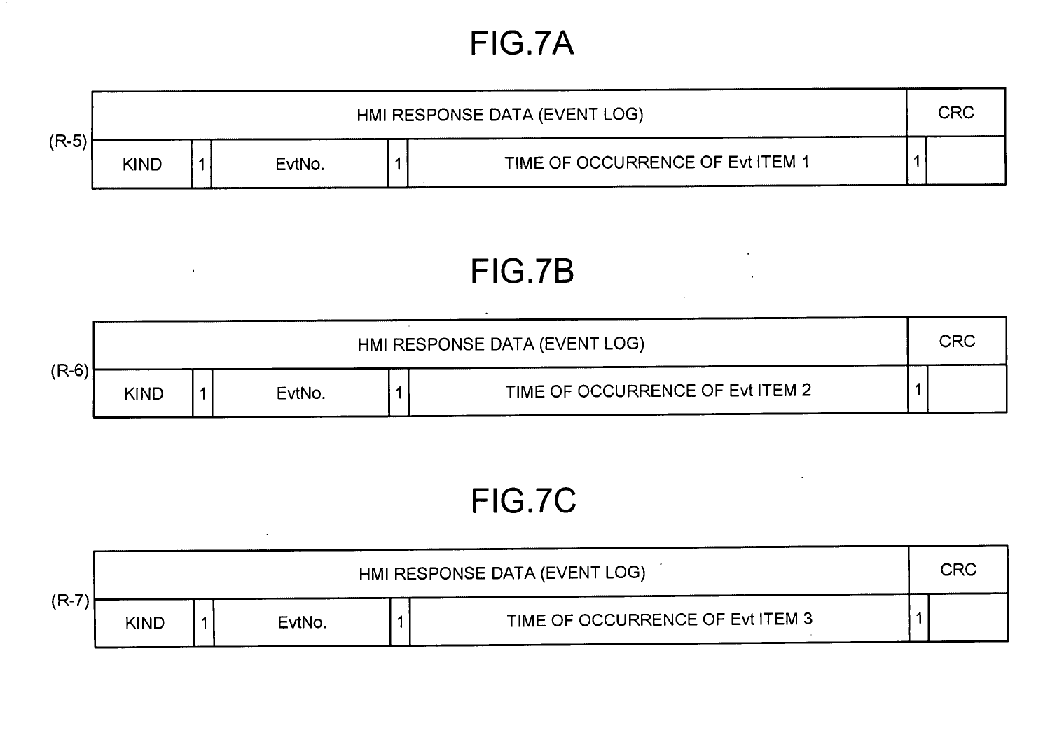

FIGS. 6 and 7A to 7C are examples of transmission data in a second embodiment. FIG. 6 shows an example of transmission data to be transmitted from the first current-differential relay device to the second current-differential relay device; and FIGS. 7A to 7C show examples of transmission data to be transmitted from the second current-differential relay device to the first current-differential relay device.

In FIG. 6, transmission data S-4 to be transmitted from the first current-differential relay device to the second current-differential relay device is a piece of the display-related data, specifically, HMI instruction data (a request for transmitting an event log) for requesting an event log of the second current-differential relay device 101b. More specifically, the transmission data S-4 consists of a kind of the HMI instruction data (KIND). In response to input operation with the push button 22 on the front panel 23a or the personal computer 21a, the HMI 9 adds the HMI instruction data (a request for transmitting an event log) in the transmission information of the first current-differential relay device 101a and transmits it.

In FIGS. 7A and 7B, transmission data R-5, R-6, and R-7 to be transmitted from the second current-differential relay device 101b to the first current-differential relay device 101a each indicate an event log that the HMI 9 of the second current-differential relay device 101b returns in response to the HMI instruction data (a request for transmitting an event log), specifically, HMI response data (an event log) as a piece of the display-related data. The event log has the amount of information depending on the time of collection of log data, and is transmitted with the number of data blocks (channels) according to the amount of information (three data blocks in this embodiment). More specifically, the transmission data R-5, R-6, and R-7 each consist of a kind of the HMI response data (KIND) and followed by an event number (EvtNo.) and the time of occurrence of event.

The transmission data S-4, R-5, R-6, and R-7 are transmitted, as the display-related data of the first embodiment, using fields containing no sampling current data in the transmission frame format for the sampling current data always transmitted from the first current-differential relay device 101a. Alternatively, the transmission data are transmitted separately in the transmission frame format.

In this way, since the current-differential relay devices according to the second embodiment transmit the display-related data (transmission data items) other than the sampling current data in the transmission frame for transmitting the sampling current data, i.e., a request for transmitting an event log and the event log, one current-differential relay device can quickly obtain the event log of the other current-differential relay device and improve analysis function, without additional specific monitoring control system and without on-site operation of the other current-differential relay device.

As described above, according to the first and the second embodiments, information indicating a setting value and an event log are transmitted, as instruction data generated based on operations of the push button 22 of the front panels 23a and 23b or the personal computers 21a and 21b and response data, in the 2048-kbps transmission frame format as shown in FIG. 12. The setting value and the event log are then displayed on the display units 103a and 103b.

In contrast, current-differential relay devices according to a third embodiment transmit information indicating relay states of relay elements and device input/output signals to one another, in the 2048-kbps transmission frame format as shown in FIG. 12. The information indicating relay states of relay elements and device input/output signals, after transmitted, are stored in the destination current-differential relay device. The information indicating relay states of relay elements and device input/output signals are then confirmed through the front panels 23a and 23b or the personal computers 21a and 21b as necessary.

In this way, one current-differential current relay device stores therein information indicating relay states of relay elements and device input/output signals of the current-differential current relay device and displays them as necessary, thereby improving analysis function of relay operation upon an occurrence of fault.

Current-differential relay devices according to a fourth embodiment transmit, to one another, measured value information including voltage, current, phase, active power, reactive power, power factor, differential current, suppressor current, and the like, as instruction information and response information of the HMI 9, in the 2048-kbps transmission frame format as shown in FIG. 12. The measured value information is also displayed on the current-differential relay device.

Accordingly, one current-differential relay device allows the measured information of the other current-differential relay device to be displayed as necessary, and it is advantageous to obtain states of the system.

Current-differential relay devices according to a fifth embodiment transmit software version information, as instruction information and response information of the HMI 9, to one another in the 2048-kbps transmission frame format as shown in FIG. 12. The software version information is also displayed on the current-differential relay device.

Accordingly, one current-differential relay device allows the software version information of the other current-differential relay device to be displayed as necessary, and it is advantageous to management the system.

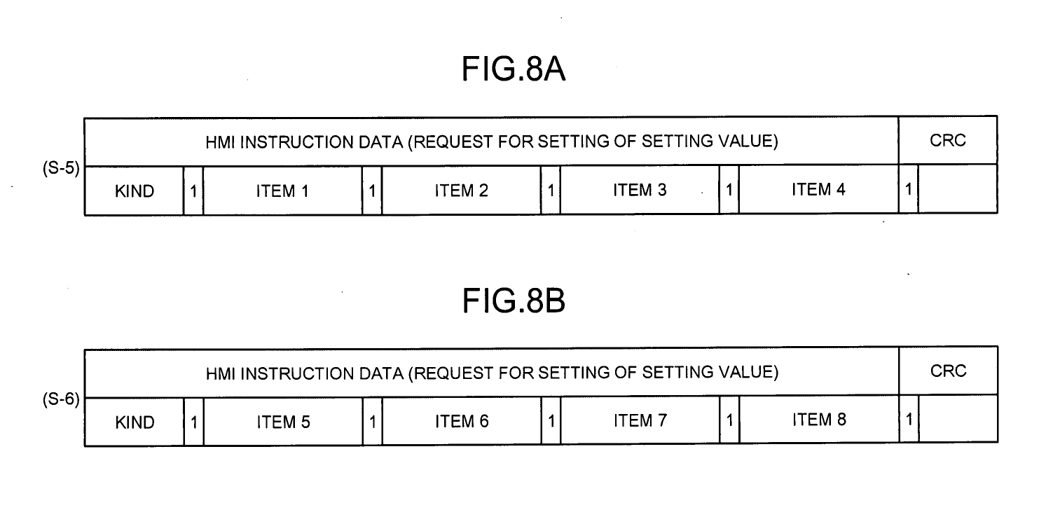

In current-differential relay devices according to a sixth embodiment, one current-differential relay device sets a setting value of the other current-differential relay device based on operations of the push button 22 of the front panels 23a a d 23b or the personal computers 21a and 21b. In FIGS. 8A to 8C, transmission data S-5 and S-6 to be transmitted from the first current-differential relay device 101a to the second current-differential relay device 101b are pieces of the display-related data, specifically, HMI instruction data (a request for setting a setting value) for requesting setting of a predetermined setting value to the second current-differential relay device 101b. More specifically, the transmission data S-5 and S-6 each consist of a kind of the HMI instruction data (KIND) and followed by setting values for respective items. The HMI 9 receives data input from the personal computer 21a and transmits it as the HMI instruction data.

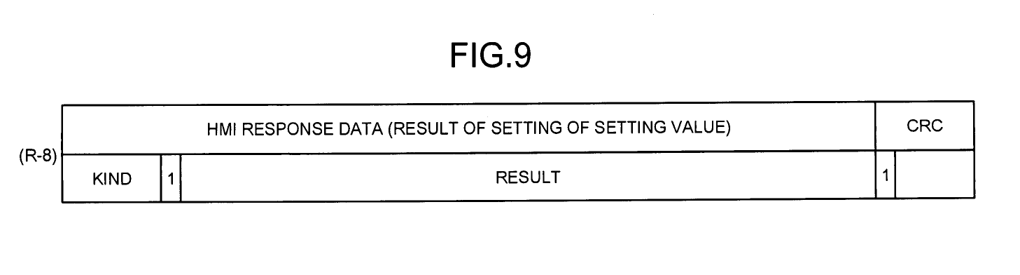

In FIG. 9, transmission data R-8 to be transmitted from the second current-differential relay device 101b to the first current-differential relay device 101a indicates a result of setting a setting value that the HMI 9 of the second current-differential relay device 101b sets the setting value in response to the HMI instruction data (a request for setting a setting value) and then returns, specifically, HMI response data (a result of setting the setting value) as a piece of the display-related data. More specifically, the transmission data R-8 consists of a kind of the HMI response data (KIND) and followed by a result of setting the setting value. The HMI 9 receives the HMI response data (a result of setting the setting value) and displays it on the personal computer 21a.

In this way, according to the sixth embodiment, one current-differential relay device transmits the request for setting a setting value in the transmission frame for transmitting the sampling current data to set the setting value on the other current-differential relay device. Accordingly, the one current-differential relay device can quickly set the setting value on the other current-differential relay device and facilitate system management, without additional specific communication medium and without on-site operation of the other current-differential relay device.

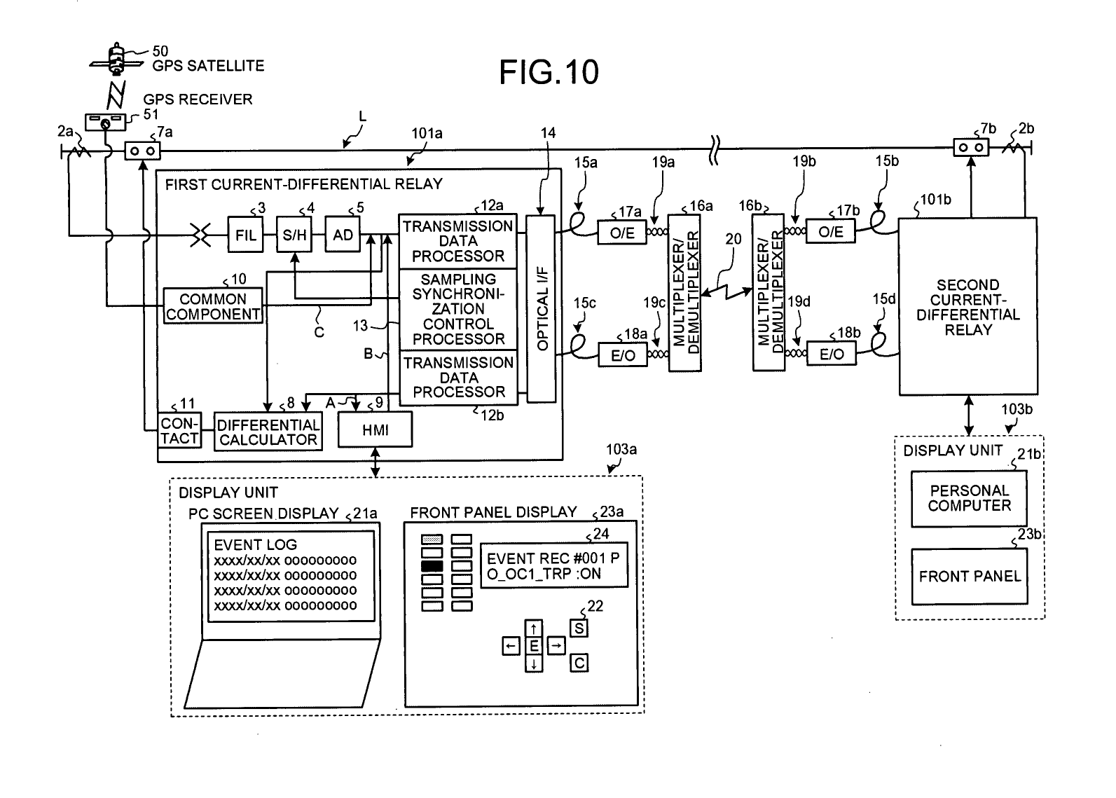

FIG. 10 shows a system configuration of a seventh embodiment of a current-differential relay device according to the present invention. The common component 10 of the first current-differential relay device 101a is connected to a GPS receiver 51 that receives time information from a GPS satellite 50. The common component 10 receives the time information from the GPS receiver 51 through the GPS satellite 50 and synchronizes the system time of the first current-differential relay device 101a with the GPS time. The common component 10 also adds the received time information in the transmission information and transmits it to the second current-differential relay device 101b, as shown with arrow C in FIG. 10. Accordingly, the common component 10 of the first current-differential relay device 101b (not shown) synchronizes the system time of the second current-differential relay device 101b with the GPS time. The common component 10 of the first current-differential relay device 101a may be referred to as a first time synchronization unit; the common component 10 of the first current-differential relay device 101b may be referred to as a second time synchronization unit.

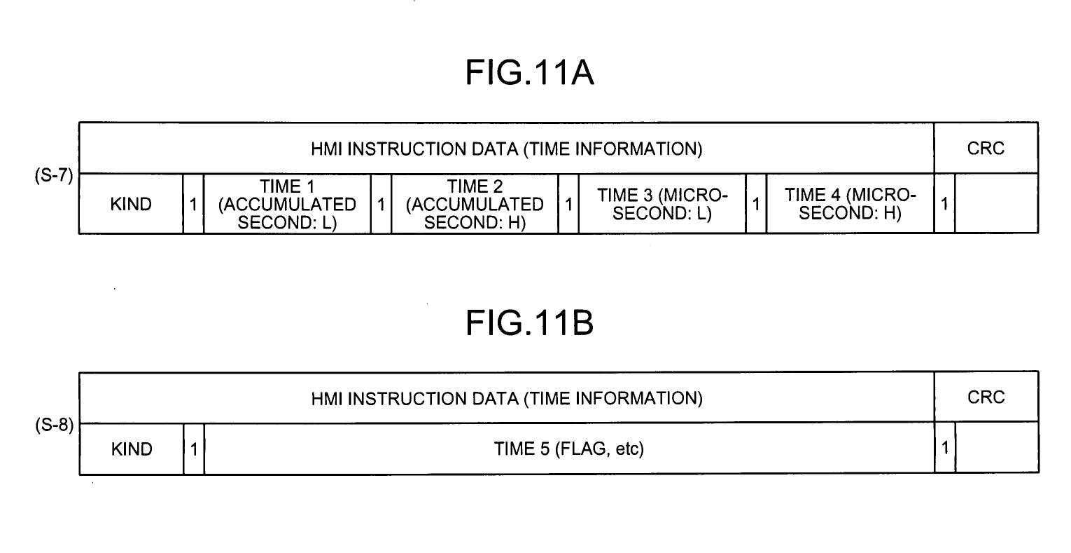

In FIGS. 11A and 11B, transmission data S-7 and S-8 to be transmitted from the first current-differential relay device 101a to the second current-differential relay device 101b are HMI instruction data (time information) for requesting time synchronization to the second current-differential relay device 101b. Specifically, the transmission data S-7 consists of a kind of the HMI instruction data (KIND) and followed by time 1 (accumulated second: L), time 2 (accumulated second: H), time 3 (microsecond: L), and time 4 (microsecond: H); the transmission data S-8 consists of a kind of the HMI instruction data (KIND) and followed by time 5 (flag, etc.).

In the seventh embodiment, the time synchronization is based on the time information obtained from the GPS receiver 51. Alternatively, the current-differential relay devices may use other accurate time, for example, time information provided by a broadcast station or a radio wave clock, and time information input from the front panels 23a and 23b or the personal computers 21a and 21b.

In this way, according to the seventh embodiment, one current-differential relay device transmits the time information used for time synchronization in the transmission frame for transmitting the sampling current data to the other current-differential relay device. Accordingly, the time synchronization between the one current-differential relay device and the other current-differential relay device can be performed easily.

According to the embodiment of the invention, since transmission data (display-related data) other than the sampling current data is transmitted with a transmission frame for transmitting the sampling current data, one current-differential relay device can quickly obtain various data on the other current-differential relay device and improve analysis function in relay operation, without additional specific monitoring control system and without on-site operation of the other current-differential relay device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A current-differential relay device, installed at one end of a power transmission line within a protected zone, the current-differential relay device comprising:
a transmission data processor for performing a transmitting process that transmits first sampling current data obtained by sampling current flowing the power transmission line at the one end to another current-differential relay device installed at the other end of the power transmission line within the protected zone, through a predetermined signal transmission line, and a receiving process that receives second sampling current data obtained by sampling current flowing the power transmission line at the other end from the another current-differential relay device through the signal transmission line;
a differential calculator for calculating a difference in electric current between the first sampling current data and the second sampling current data, the difference being used for detection of an occurrence of fault in the protected zone; and
a human-machine interface capable of receiving and presenting information through a display unit;
wherein the signal transmission line has a transmission rate of 2048 kbps or higher,
wherein the transmission data processor transmits the first sampling current data in a transmission frame used in the signal transmission line, and transmits, using an unused field not for the sampling current data in the transmission frame, display-related data that is output from the human-machine interface.

2. The current-differential relay device according to claim 1, wherein the display-related data includes
a request for transmitting a setting value, being output from the human-machine interface, and
a setting value that is output from a human-machine interface of the another current-differential relay device in response to the request for transmitting the setting value.

3. The current-differential relay device according to claim 1, wherein the display-related data includes
a request for transmitting an event log, being output from the human-machine interface, and
an event log that is output from a human-machine interface of the another current-differential relay device in response to the request for transmitting the event log.

4. The current-differential relay device according to claim 1, wherein the display-related data includes
a state of a relay element and a device input/output signal which are output from the human-machine interface.

5. The current-differential relay device according to claim 1, wherein the display-related data includes measured value information which is output from the human-machine interface.

6. The current-differential relay device according to claim 1, wherein the display-related data includes software version information.

7. The current-differential relay device according to claim 1, wherein the display-related data includes
a request for setting a setting value, being output from the human-machine interface, and
a result of setting the setting value that is output from a human-machine interface of the another current-differential relay device in response to the request for setting the setting value.

8. The current-differential relay device according to claim 1, further comprising a time synchronization unit for synchronizing a time used in the current-differential relay device with a GPS time received from a GPS receiver, wherein
the display-related data transmitted to the another current-differential relay device includes time information of the time synchronization unit.

9. The current-differential relay device according to claim 1, further comprising a time synchronization unit for synchronizing a time used in the current-differential relay device with time information that is synchronized based on a GPS time, wherein
the display-related data received from the another current-differential relay device includes the time information.
